(19) United States
(12) Patent Application Publication
(10) Pub. No.: US 2026/0343308 A1
(43) Pub. Date: Oct. 29, 2026

(54) DYNAMIC RAN ASSISTANCE INFORMATION REPORTING FOR TIME SENSITIVE COMMUNICATION

(71) Applicant: Telefonaktiebolaget LM Ericsson (publ), Stockholm (SE)

(72) Inventors: Dhruvin PATEL, AACHEN (DE); Joachim SACHS, SOLLENTUNA (SE); János FARKAS, KECSKEMÉT (HU); János HARMATOS, Budapest (HU); Balázs VARGA, BUDAPEST (HU); Marilet De Andrade JARDIM, KISTA (SE); György MIKLÓS, PILISBOROSJENÖ (HU)

(73) Assignee: Telefonaktiebolaget LM Ericsson (publ), Stockholm (SE)

(21) Appl. No.: 19/123,385

(22) PCT Filed: Nov. 7, 2022
(86) PCT No.: PCT/SE2022/051021

§ 371 Date: Apr. 22, 2025

(51) Int. Cl. H04W 28/02; H04L 41/0816; H04L 41/0894; H04W 24/08; H04W 28/16

(52) U.S. Cl. CPC H04W 28/0236; H04L 41/0816; H04L 41/0894; H04W 24/08; H04W 28/16

(57) ABSTRACT

Embodiments of the present disclosure provide a method (500) performed for transmission of Radio Access Network, RAN, assistance information for time sensitive communication in a Time-Sensitive Networking, TSN, system (100). The TSN system (100) is integrated to a wireless communication network (80) being operated as a virtual TSN node. The virtual TSN node (80) being connected to a plurality of TSN nodes (70a, 70b). The method (500) is performed by a network node (40a) in the wireless communication network (80). The method (500) comprises detecting (502) an occurrence of an event causing variation of radio link characteristics of one or more U ser Equipments, UEs (30), connected to the network node (40a). Upon detecting the occurrence of the event, the method comprises transmitting (504) the RAN assistance information, said RAN assistance information being intended for a Centralized Network Controller, CNC (90), and comprising information indicating the variation of the one or more metrics to enable the CNC for reconfiguration of the TSN system (100).

Corresponding network node, and computer program products are also disclosed.

### TECHNICAL FIELD

The present disclosure relates generally to the field of Time Sensitive Networking, TSN, systems. More particularly, it relates to method, network node, and computer program products for dynamic Radio Access Network, RAN, assistance information reporting for time sensitive communication in a TSN system integrated to a wireless communication network.

### BACKGROUND

An automation industry is undergoing a digital transformation towards the “Fourth Industrial Revolution” (Industry 4.0), which involves smart manufacturing. Flexible connectivity infrastructure provided by the automation industry is a key enabler for manufacturing to interconnect machines, products and all kinds of other devices in a flexible, secure, and consistent manner.

Communication technology enablers for the digital transformation of the automation industry are Time Sensitive Networking, TSN, system (TSN network) on a wireline side, and a Third Generation Partnership Project, 3GPP, Fifth Generation, 5G, network on a wireless side. The TSN system is based on the Institute of Electrical and Electronics Engineers, IEEE 802.3 Ethernet standard. The TSN system provides deterministic services through IEEE 802.3 networks, for example, time synchronization, guaranteed low latency transmissions and high reliability. The 5G network, an alternative to a wired connectivity solution supports communication with unprecedented reliability and very low latency, as well as massive Internet of Things, IoT, connectivity. Thus, the TSN system and the 5G network are considered as complementary technologies in providing deterministic communication services, thereby paying the way towards future advanced manufacturing systems and other vertical areas. Also, the TSN system and the 5G network are essential for network convergence that is a support of all kinds of communication services via a same network infrastructure. Therefore, the TSN system can be integrated to the 5G network, which supports the deterministic communication services over heterogeneous infrastructure and multiple application domains required for the network convergence. The integration of the TSN system to the 5G system provides converged communication on the same network infrastructure for a wide range of services, for example, time sensitive applications that require deterministic, reliable and low latency communications.

With the integration of the TSN system to the 5G network, the 5G network is deployed as a set of IEEE compliant virtual TSN nodes (also be referred to as virtual TSN bridges). The virtual-TSN node can be connected to TSN nodes (also be referred to wired TSN nodes/bridges). The 5G network comprises a 5G core network and a Radio Access Network, RAN. A User Plane Function, UPF, of the 5G core network acts as a gateway to the TSN system. The RAN spans over a production plant to provide wireless connectivity to one or more User Equipments, UEs.

The 5G network or the 5G system which is acting as a virtual TSN node consists of a TSN Application Function, AF, device side TSN translators, DS-TTs on the UEs, and network side TSN translators, NW-TT on the UPF. The TSN AF connects a Centralized Network Controller, CNC, a Centralized User Configuration, CUC and a 5G control plane.

The CNC controls/operates the TSN nodes and the virtual TSN node as the TSN node. However, there exist some substantial differences between the 5G network/virtual TSN node and the TSN node. As the differences between the virtual TSN node and the TSN node are hidden, the CNC cannot consider such differences into account while scheduling time sensitive communication in the TSN system. Thus, resulting in suboptimal behaviour with respect to leveraging capabilities of the 5G network and potential benefits for end-to-end time sensitive communication.

A key difference between the TSN nodes and the virtual TSN node is that characteristics of the virtual TSN node may vary dynamically, especially compared to relatively static characteristics of the TSN nodes. When the characteristics of the virtual TSN node change, a new interaction between the virtual TSN node and the CNC may be triggered. If the change in the characteristics of the virtual TSN node is due to fast fluctuations of wireless transmissions, then the fast fluctuations of the wireless transmission may be covered by a larger Packet Delay Variation, PDV, and it may not require a new interaction to be triggered between the virtual TSN node and the CNC. However, if the change in characteristics of the virtual TSN node is due to different events, then the new interaction is required to be triggered between the virtual TSN node and the CNC. The events may include, but are not limited to, a change of carrier frequency of the one or more UEs, connection or disconnection of the one or more U Es from the UPF of the 5G core network, and so on. For example, the change of the carrier frequency of the UE (for example, between 3.7 Giga Hertz, GHz and 26 GHz) implies a different characterization of latency behaviour for the DS-TTs/NW-TTs of the virtual TSN node represented by the UE. For another example, connection or disconnection of the one or more U Es from the UPF results in addition or removal of new DS-TTs/NW-TTs of the virtual TSN node. All these events lead to the new interactions between the 5G network and the CNC causing a possible reconfiguration of the TSN system (i.e., re-planning of many TSN traffic flows). With a typical 5G network deployment with 100's of UEs connected to the single UPF, the single virtual TSN node is created with 100's of NW-TTs. Due to such a deployment, a number of events causing the new interactions between the 5G network and the CNC may increase, which further causes frequent reconfiguration of the TSN system. Such frequent reconfiguration of the TSN system may create significant load on the CNC and the load may further lead to undesirable fluctuations of traffic handling throughout the TSN network.

In addition to the above mentioned events, mobility/handover of the one or more UEs is an important aspect when considering integration of the TSN system to the 5G network. A main use case for the mobility in the smart manufacturing involves Automated Guided Control, AGV, or mobile robots, where the integrated TSN-5G network plays an important role in connecting such robots to a cloud based robotic control application. In case of the handover of the one or more UEs, mobility of such U Es may be hidden from the TSN network and the CNC. The handover of the one or more UEs is rather considered as a 5G internal procedure that occurs within the 5G network/virtual TSN node. In such a situation, there is a possibility of change in performance (mainly includes latency) of TSN streams flowing between the DS-TTs and the NW-TTs of the particular virtual TSN node. The change in performance of the TSN streams leads to deviation in minimum-maximum, min-max, latency performance of the virtual TSN node reported to the CNC.

For example, when the UE associated to the DS-TT undergoes handover to another network node with different carrier frequencies or configurations, radio link characteristics/latency of TSN streams flowing between the DS-TTs and the NW-TTs may be varied. However, there is no reporting of such a change in the radio link characteristics of the TSN stream to the CNC, which results in different performance between the DS-TTs and NW-TTs.

### SUMMARY

It is important to monitor and report the one or more events causing the change in the radio link characteristics of the one or more U Es connected to the network node in the virtual TSN node. Otherwise resulting in different performance between the DS-TTs and NW-TTs.

Consequently, there is a need for an improved method and arrangement for transmission of Radio Access Network, RAN assistance information indicating variation of radio link characteristics of one or more User Equipments, U Es, for time sensitive communication that alleviates at least some of the above-cited problems.

It is therefore an object of the present disclosure to provide a method, a network node, and a computer program product for transmission of Radio Access Network, RAN assistance information for time sensitive communication in a Time Sensitive Networking, TSN, system, to mitigate, alleviate, or eliminate all or at least some of the above-discussed drawbacks of presently known solutions.

This and other objects are achieved by means of a method, a network node, and a computer program product as defined in the appended claims. The term exemplary is in the present context to be understood as serving as an instance, example or illustration.

According to a first aspect of the present disclose, a method performed for transmission of Radio Access Network, RAN assistance information for time sensitive communication in a Time Sensitive Networking, TSN, system is provided. The method is performed by a network node of a wireless communication network. The wireless communication network operates as a virtual TSN bridge of the TSN system. The method comprises detecting an occurrence of an event causing variation of radio link characteristics of one or more User Equipments, UEs, connected to the network node. Upon detecting the occurrence of the event, the method comprises transmitting the RAN assistance information, said RAN assistance information being intended for a Centralized Network Controller, CNC (90), and comprising information indicating the variation of the radio link characteristics to enable the CNC for reconfiguration of the TSN system (100).

In some embodiments, the step of detecting the occurrence of the event causing variation of radio link characteristics of the U Es comprises obtaining information identifying at least one of one or more metrics related to the radio link characteristics for monitoring and at least one of the one or more UEs. The method comprises monitoring the identified one or more metrics for the identified one or more U Es for detecting the occurrence of the event. In some embodiments, the one or more metrics related to the radio link characteristics of the one or more UEs comprise one or more of: the DS-TTs being utilized for one or more TSN streams associated with the one or more U Es, and a mapping between the DS-TTs and the NW-TTs, and a mapping between the DS-TTs and the NW-TTs.

In some embodiments, the event comprises one or more of: a handover of the one or more UEs to another network node, a change of carrier frequency of the one or more UEs, connection and/or disconnection of the one or more U Es from a User Plane Function, UPF, of a core network connected to the network node, a change in performance of at least one TSN stream flowing between device side TSN translators, DS-TTs, associated with the one or more UEs and network side TSN translators, NW-TTs, associated with the U PF of the core network, a change in a mapping between the DS-TTs and the NW-TTs, a change in an operation mode of the network node, and a change in latency characteristics of the operation mode of the network node.

In some embodiments, the step of transmitting the RAN assistance information intended to the CNC comprises measuring the one or more metrics of the one or more UEs (30a, 30b) varied due to the occurrence of the event. The method comprises generating, in accordance with the measurement, the RAN assistance information for indicating the variation of the radio link characteristics of the one or more UEs. The method comprises transmitting the RAN assistance information intended to the CNC.

In some embodiments, the step of transmitting the RAN assistance information comprises transmitting the RAN assistance information intended to the CNC through a TSN Application Function, TSN AF.

In some embodiments, the RAN assistance information is transmitted to the TSN AF through a Session Management Function, SMF, of the CN.

In some embodiments, transmission of the RAN assistance information to the TSN AF through the SMF comprises deriving, at the SMF from the RAN assistance information, one latency parameter for each TSN stream and one latency parameter for each stream for each UE. The method comprises forwarding the derived latency parameters from the SM F to the TSN AF.

In some embodiments, the latency parameters comprise one or more of: updated minimum/maximum latency between the DS-TTs associated with the one or more UEs and maximum latency monitored during the occurrence of the event for each TSN stream.

In some embodiments, the RAN assistance information comprises one or more of: information about latency measured in the network node, information about latency distribution in the TSN system, and information about downlink and uplink latency related to the at least one TSN stream.

According to a second aspect of the present disclosure, a method for reception of Radio Access Network, RAN, assistance information for time sensitive communication in a Time-Sensitive Networking, TSN system is provided. The TSN system is integrated to a wireless communication network. The wireless communication network is operated as a virtual TSN bridge of the TSN system. The method is performed by a Centralized Network Controller, CNC, of the TSN system. The method comprises receiving, from a network node in the wireless communication network, the RAN assistance information comprising information indicating variation of radio link characteristics of one or more UEs connected to the network node. The method comprises performing, in accordance with the RAN assistance information, reconfiguration of the TSN system.

In some embodiments, the step of performing reconfiguration of the TSN system comprises one or more of: updating port configurations for device side TSN translators, DS-TTs, associated with the one or more UEs, and updating latency characteristics of the DS-TTs associated with the one or more UEs.

In some embodiments, the RAN assistance information comprises one or more of: information about latency measured in the network node, information about latency distribution in the TSN system, and information about downlink and uplink latency related to at least one TSN stream.

According to a third aspect of the present disclosure, an apparatus of a network node in a wireless communication network configured to perform transmission of Radio Access Network, RAN, assistance information for time sensitive communication in a Time-Sensitive Networking, TSN, system is provided. The wireless communication network is operating as a virtual TSN bridge of the TSN system. The apparatus is configured to cause detection of an occurrence of an event causing variation of radio link characteristics of one or more User Equipments, UEs, connected to the network node. Upon detecting the occurrence of the event, the apparatus is configured to cause transmission of the RAN assistance information, said RAN assistance information being intended for a Centralized Network Controller, CNC and comprising information indicating the variation of the radio link characteristics to enable the CNC for reconfiguration of the TSN system.

A fourth aspect is a network node comprising the apparatus of the third aspect.

According to a fifth aspect of the present disclosure, a Centralized Network Controller, CNC, for reception of Radio Access Network, RAN, assistance information for time sensitive communication in a Time-Sensitive Networking, TSN system is provided. The TSN system is integrated to a wireless communication network and the wireless communication network is operating as a virtual TSN bridge of the TSN system. The CNC is configured for receiving from a network node in the wireless communication network, the RAN assistance information comprising information indicating variation of radio link characteristics of one or more User Equipments, UEs, connected to the network node. The CNC is configured for performing, in accordance with the RAN assistance information, reconfiguration of the TSN system.

According to a sixth aspect of the present disclosure, there is provided a computer program product comprising a non-transitory computer readable medium, having thereon a computer program comprising program instructions, wherein the computer program is loadable into a data processing unit and configured to cause execution of the method according to any of the first and second aspects when the computer program is run by the data processing unit.

In some embodiments, any of the above aspects may additionally have features identical with or corresponding to any of the various features as explained above for any of the other aspects.

An advantage of some embodiments is that alternative and/or improved approaches are provided for the transmission of the RAN assistance information intended to the CNC for managing time sensitive communication in the TSN system. Thus, resulting in dynamic reporting from the wireless network towards the CNC for enabling the CNC to reconfigure the TSN system.

An advantage of some embodiments is that the RAN assistance information comprises information indicating variation of the radio link characteristics of the one or more U Es caused by the event. As a result, the CNC may aware of change in the radio link characteristics of the one or more UEs and accordingly reconfigure the TSN system.

An advantage of some embodiments is that reconfiguring the TSN system based on the RAN assistance information does not impact performance/latency of the TSN streams belonging to the one or more U Es or performance of the DS-TTs and the NW-TTs.

An advantage of some embodiments is that reconfiguring the TSN system based on the RAN assistance information may prevent undesirable fluctuations of traffic handling (i.e., handling of the time sensitive communication) throughout the TSN network.

An advantage of some embodiments is that the RAN assistance information is transmitted to the CNC upon identification of the event causing the variation of the one or more metrics related to the radio link characteristics of the one or more UEs. As a result, an unnecessary load on the CNC to reconfigure the TSN system may be eliminated.

Other advantages may be readily apparent to one having skill in the art. Certain embodiments may have none, some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses an example of a Time Sensitive Networking, TSN, system integrated to a wireless communication network according to some examples;

FIG. 2 discloses an example of a TSN system integrated to a wireless communication network, which acts as a virtual TSN node according to some examples;

FIG. 3 discloses an example of a wireless communication network according to some examples;

FIGS. 4A and 4B disclose an example architecture of a TSN system integrated to a wireless communication network according to some examples;

FIG. 5 is a flowchart illustrating example method steps according to some examples;

FIG. 6 is a flowchart illustrating example method steps according to some examples;

FIG. 7 is a signaling diagram illustrating example signaling according to some examples;

FIG. 8 is a schematic block diagram illustrating an example apparatus according to some embodiments;

FIG. 9 is a schematic block diagram illustrating an example apparatus according to some embodiments; and

FIG. 10 discloses an example computing environment according to some examples.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Network node: As used herein, a network node (also be referred to as radio access node, radio network node, or the like) is any node in a Radio Access Network, RAN, of a wireless communication network that operates to wirelessly transmit and/or receive signals. Some examples of the network node include, but are not limited to, a base station (for example a New Radio, NR, base station, gNB, in a Third Generation Partnership Project, 3GPP, Fifth Generation, 5G, NR network or an enhanced or evolved Node B, eNB, in a 3GPP Long Term Evolution, LTE, network), a high-power or macro base station, a low-power base station (for example, a micro base station, a pico base station, a home eNB, or the like), a relay node, and so on.

Core network node: As used herein, a core network node is any type of node in a core network that implements a core network function. Some examples of the core network node include, for example, a Mobility Management Entity, MME, a Packet Data Network Gateway, P-GW, a Service Capability Exposure Function, SCEF, a Home Subscriber Server, HSS, or the like. Some other examples of the core network node include a node implementing an Access and Mobility Function, AMF, a User Plane Function, UPF, a Session Management Function, SMF, an Authentication Server Function, AUSF, a Network Slice Selection Function, NSSF, a Network Exposure Function, NEF, a Network Repository Function, NRF, a Policy Control Function, PCF, a Unified Data Management, UDM, and so on.

User Equipment, UE: As used herein, a UE (also be referred to as wireless device) is any type of device that has access to (i.e., is served by) a wireless communication network by wirelessly transmitting and/or receiving signals to a network node(s). Some examples of the UE are a target device, a device to device, D2D, UE, a machine type UE, a UE capable of machine to machine, M2M, communication, personal digital assistant, PDA, tablet, mobile terminals, smart phone, laptop embedded equipped, LEE, laptop mounted equipment, LME, universal serial bus, USB, dongles, UE category M2, ProSe UE, and so on.

Note that the description given herein focuses on a 3GPP wireless communication network and, as such, 3GPP terminology or terminology similar to 3GPP terminology is oftentimes used. However, the concepts disclosed herein are not limited to a 3GPP system.

Embodiments of the present disclosure will be described and exemplified more fully hereinafter with reference to the accompanying drawings. The solutions disclosed herein can, however, be realized in many different forms and should not be construed as being limited to the examples set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

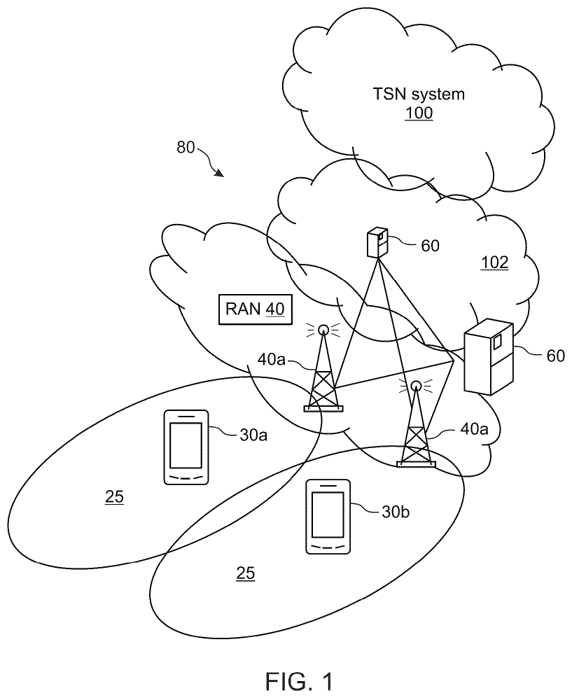

FIG. 1 discloses an example of a Time Sensitive Networking, TSN, system, 100 integrated to a wireless communication network 80. A s depicted in FIG. 1, the TSN system 100 may be integrated with the wireless communication network 80 to provide converged communication on a same network infrastructure for a wide range of services, for example, time sensitive applications that require deterministic, reliable and low latency communications.

The TSN system (also be referred to as TSN network) 100 may be based on the Institute of Electrical and Electronics Engineers, IEEE 802.3 Ethernet standard. The TSN system may provide deterministic services through IEEE 802.3 networks, for example, time synchronization, guaranteed low latency transmissions and high reliability.

The wireless communication network (also be referred to wireless communication system, cellular communication network/system, or the like) may be a wireless network, for example, a Fifth Generation, 5GS, network, a Long Term Evolution, LTE, network, an Evolved Universal Terrestrial Radio Access Network, E-UTRAN, a Wideband Code Division Multiple Access, WCDMA, network, a Global System for Mobile communications, GSM, network, a Worldwide Interoperability for Microwave Access, WiMAX, or any other future generation network.

The wireless communication network 80 comprises a Radio Access Network, RAN, 40 and a core network, CN, 60. The wireless communication network 100 may use a number of different Radio Access Technologies, RATs, such as LTE, LTE-Advanced, 5G, WCDMA, GSM/Enhanced Data rate for GSM Evolution, EDGE, WiMAX, Ultra Mobile Broadband, WMB, or the like.

The RAN 40 comprises one or more network nodes 40a, each providing radio coverage over one or more geographical areas, such as cells 25 supporting the one or more RATs. In some examples, the network node 40a may be a radio access node such as a radio network controller, an access point such as a Wireless Local Area Network, WLAN, access point or an Access Point Station, AP STA, an access controller, a base station, a base transceiver station, an Access Point base station, a base station router, a transmission arrangement of a radio base station, a standalone access point, or any other unit of the RAN capable of serving one or more User Equipments, UEs 30a, 30b, in the cell/service area. Examples of the base station may include, a gNodeB, gNB, an evolved Node B, eNB, and so on.

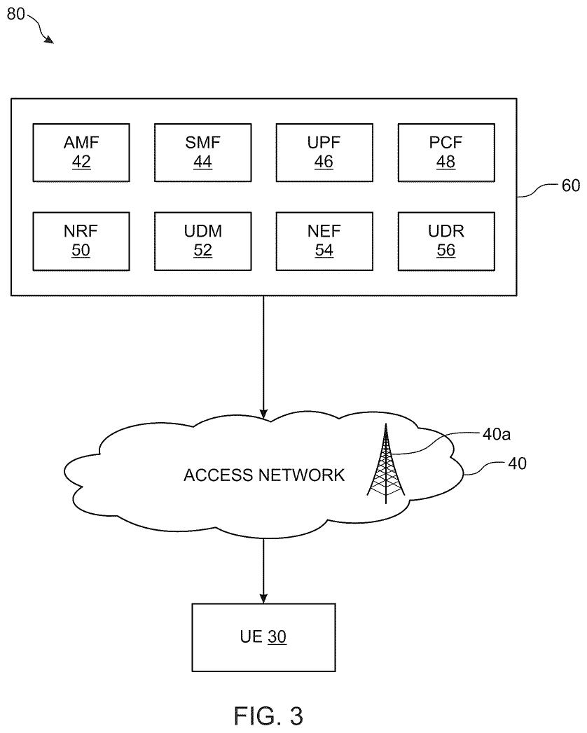

The CN 60 comprises a core network node. The core network node may be configured to communicate with the network node 40a via an interface, for example, an S1 interface. Examples of the core network node may include, a Mobile Switching Centre, MSC, a Mobility Management Entity, MME, an Operation and Management, O&M, node, an Operation, Administration and Maintenance, OAM, node, an Operations Support Systems, OSS, node, a Self-Organizing Network, SON, node, a Packet Data Network Gateway, P-GW, a Service Capability Exposure Function, SCEF, a Home Subscriber Server, HSS, or the like. The core network node may further be a distributed node comprised in a cloud 102. The core network node may further include a node implementing network functions of the CN 60 such as but are not limited to, an Access and Mobility Function, AMF, a User Plane Function, UPF, a Session Management Function, SMF, an Authentication Server Function, AUSF, a Network Slice Selection Function, NSSF, a Network Exposure Function, NEF, a Network Repository Function, NRF, a Policy Control Function, PCF, a Unified Data Management, UDM, and so on. The network functions of the CN 60 are described in detail in conjunction with FIG. 3.

In the wireless communication network 80, the one or more UEs 30a and 30b (collectively referred to as UE 30) may communicate with the CN 60 via the network nodes 40a of the RAN 40. Examples of the UE 30 may include, a wireless device, a mobile station, a non-access point, non-AP, station, STA, a wireless terminal, or the like. It should be understood by those skilled in the art that “wireless device” is a non-limiting term, which means any terminal, a wireless communication terminal, a User Equipment, a Mobile Type Communication, MTC, device, a Device to Device, D2D, terminal, or a node for example, a smart phone, a laptop, a mobile phone, a sensor, a relay, a mobile tablet, or even a base station communicating within the cell.

The UE 30 may be located in the cell 25 of the network node 40a, which is referred to as a serving cell and the cell of other network nodes may be referred to as neighbouring cells for the UE 30. Although the network node 40a, in FIG. 1, is only providing a serving cell 25, the network node 40a may further provide one or more neighbouring cells to the serving cell 25.

The UE 30 (also be referred to as first end station) may be connected to one or more end stations such as one or more second end stations. The second end station may include, but are not limited to, robots, a factory floor, or the like.

The wireless communication network 80 may according to some embodiments herein communicate with one or more nodes in the TSN system 100. The TSN system 100 may be connected to one or more end stations, such as, the second end stations.

According to some embodiments herein, with the integration of the TSN system 100, the wireless communication network 80 operates as a TSN virtual node (also be referred to as TSN virtual bridge, virtual wireless bridge, or the like).

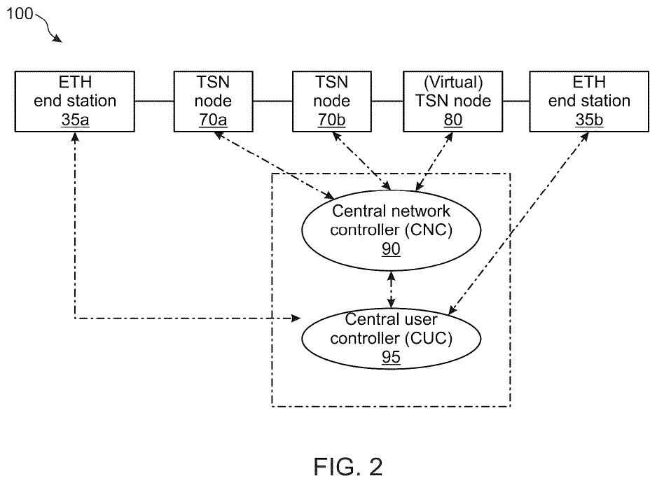

FIG. 2 discloses an example of the TSN system 100 integrated to the wireless communication network 80, wherein the wireless communication network 80 operates as the virtual TSN bridge. The TSN system 100 comprises one or more TSN nodes. For simplicity, the TSN system 100 comprising TSN nodes 70a and 70b is depicted in FIG. 2. The TSN nodes 70a and 70b may be wired TSN nodes (also be referred to as wired nodes, wired TSN bridges, or the like). With the integration of the TSN system 100 to the wireless communication network 80, the TSN system 100 may comprise the virtual TSN node 80. The virtual TSN node 80 referred herein may be the wireless communication network 80 or the virtual TSN node 80 may be a node implemented by the wireless communication network 80.

The TSN nodes 70a and 70b, and the virtual TSN node 80 may be connected to one or more end stations, for example, second end stations, which suppose to exchange time sensitive communication. The time sensitive communication may comprise TSN streams or TSN packets, or TSN flows to be exchanged between the end stations. As depicted in FIG. 2, the TSN node 70a may be connected to an end station 35a and the virtual TSN node 80 may be connected to an end station 35b. Examples of the end stations 35a and 35b may include, but are not limited to, robots, a factory floor, or the like. The end stations 35a and 35b may be connected to the U Es associated with the virtual TSN node 80 through the TSN nodes 70a/70b (not shown).

In some examples, the TSN nodes 70a and 70b, the virtual TSN node 80, and the end stations 35a and 35b may be configured in a static configuration setup or a centralized network configuration setup. In the static configuration setup, the TSN nodes 70a and 70b, the virtual TSN node 80, and the end stations 35a and 35b may be configured during network setup. In the centralized network configuration setup, a Centralized Network Controller, CNC, 90 (also be referred to as centralized network configuration) may configure the TSN nodes 70a and 70b, and the virtual TSN node 80 for TSN streams (data packets exchanged between the end stations through the TSN nodes 70a and 70b and the virtual TSN node 80). The CNC 90 may be adapted for configuring network resource reservations for the TSN nodes 70a and 70b, and the virtual TSN node 80. The CNC 90 may also be adapted for coordinating any changes to the configured network resource reservations with any new reservations. The network resource reservations may be made or requested by the end stations 35a and 35b. In the fully centralized network configuration setup where both network and user configuration are centralized, the CNC may receive requirements of data flows from a Centralized User Controller, CUC, 95 (also be referred to as centralized user configuration) and then compute a route, and a time schedule required for end-to-end, E2E, transmission for each TSN stream. The CNC may also configure the TSN nodes 70a and 70b and the virtual TSN node 80 in accordance with the computed route and time schedule.

In some embodiments, the wireless communication network acting as the virtual TSN node 80 may obtain, from a controller of the TSN system (not shown), one or more TSN Quality of Service, QoS, parameters and information related to a traffic pattern for the virtual TSN node 80. The TSN QoS parameters may be mapped to QoS policy(ies) and/or rules in the wireless communication network and applied in the wireless communication network in order to satisfy TSN QOS requirements for the virtual TSN node. In addition, at least some of the information related to the traffic pattern for the virtual TSN node may be provided to an edge node to achieve the desired traffic pattern. In some examples, the edge node may be the UPF of the CN for uplink direction or the UE for downlink direction.

In some other embodiments, the wireless communication system operating as the virtual TSN node 80 may obtain, from the controller of the TSN system, information related to the traffic pattern for the preceding TSN node 70b (the TSN node that precedes the virtual TSN node 80 in a direction of TSN traffic flow). At least some of the information related to the traffic pattern for the preceding TSN node 70b may be provided to the one or more network nodes of the wireless communication system for radio optimization. Components of the wireless communication network operating as the virtual TSN node 80 is described in detail in conjunction with FIG. 3.

FIG. 3 discloses the wireless communication network 80 operating as the virtual TSN node, while integrated to the TSN system. As depicted in FIG. 3, the wireless communication network 80 comprises the RAN 40, the CN 60, and the UE 30. The RAN 40 includes the network node 40a.

The network node 40a may be directly connected to the UE 30. The network node 40a may include a group of a plurality of base stations including a base station, and the plurality of base stations may perform communication via an interface. The base station may have a structure having a central unit, CU, and a distributed unit, DU, separated from each other. In this case, one CU may control a plurality of DUs. The base station may be referred to as an access point, AP, a next-generation node i.e., a gNB, a 5th generation node, a wireless point, or a transmission/reception point, TRP, or the like. The UE 30 accesses the RAN 40 and communicates with the network node 40a through a wireless channel. The UE 30 may be a user equipment, UE, a mobile station, a subscriber station, a remote terminal, a wireless terminal or the like.

The CN 60, which is the network that manages or controls the RAN 40 and processes data and control signals for the UE 30, transmitted and received via the RAN 40. The CN 60 may perform various functions including control of a user plane and a control plane, processing of mobility, management of subscriber information, charging, and interworking with other types of systems such as, LTE, system.

To perform the various functions described above, the CN 60 may include a plurality of functionally separated entities (i.e., core network nodes) having different network functions. For example, the network functions may include an AMF 42, a SMF 44, a UPF 46, a PCF 48, a network repository function, NRF 50, a UDM 52, a NEF 54, and a unified data repository UDR 55. Although, not shown in FIG. 3, the CN 60 may interwork with a TSN Application Function, AF, the CNC and the TSN system. In some examples, the CN 60 may be referred as a 5th generation, 5G, core, 5GC, which is a core network of a 5G system.

The UE 30 connected to the RAN 40 may accesses the AM F 42, which performs a mobility management function of the CN 60. The AMF 42 is a function or a device that is responsible for both access to the RAN 40 and the mobility management of the UE 30. The SMF 44 is a network function that manages a session. The AMF 42 may be connected to the SMF 44, and the AMF 42 may route session-related messages of the UE 30 to the SMF 44. The SMF 44 may be connected to the UPF 46 to allocate a user plane resource to be provided to the UE 30 and establish a tunnel for transmitting data between the network node 40a and the UPF 46. The SMF 44, as a main entity managing a PDU session, may be responsible for QoS setting/update for QoS flows in the PDU session. The PCF 48 may control information associated with a policy and charging of a session used by the UE 30. The NRF 50 may be connected to all the network functions. Each network function is registered with the NRF 50 when starting to run in the operator network, so as to inform the NRF 50 that the network function is running in the wireless communication network 80. The UDM 52, as a network function may perform a role similar to a home subscriber server, HSS, of a 4G network, and store subscription information of the UE 30 or context information used by the UE 30 in the network.

The NEF 54 may serve to connect a third party server to the network function in the wireless communication network 80. In addition, the NEF 54 may serve to provide data to the UDR 56 and to update or obtain data. The UDR 56 may serve to store subscription information of the UE 30, store policy information, store data exposed to the outside, or store information necessary for a third-party application. Further, the UDR 56 may also serve to provide stored data to other network functions.

The UDM 52, PCF 48, SMF 44, AMF 42, NRF 50, NEF 54, and UDR 56 may be connected to a service-based interface. Services or application programing interfaces, APIs, provided by these network functions are used by other network functions and thus may exchange control messages with each other. For example, when the AMF 42 delivers a session-related message to the SMF 44, a service or A PI called Nsmf_PDU Session_CreateSM Context may be used.

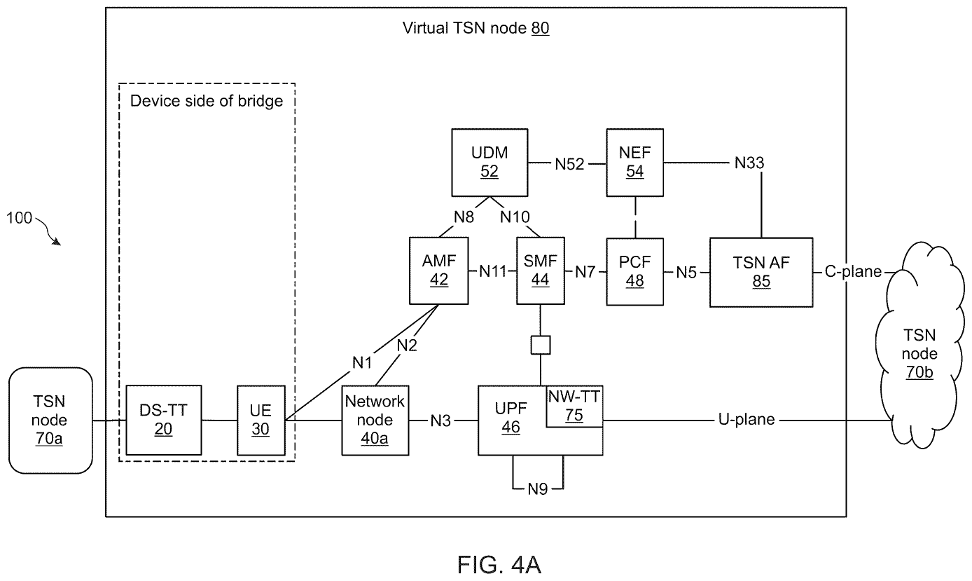

FIGS. 4A and 4B disclose an example architecture of the TSN system 100 integrated with the wireless communication network 80 in which embodiments of the present disclosure may be implemented. For a seamless integration between the wireless communication network 80 and the TSN system 100, the wireless communication network 80 and the TSN system 100 may interoperate in a transparent manner to minimize impact on other TSN entities.

With the integration of the TSN system 100 to the wireless communication network 80, the TSN system 100 comprises the one or more TSN nodes/wired TSN bridges 70a and 70b, and the virtual TSN node 80. The TSN nodes 70a and 70b and the virtual TSN node 80 are described in detail in conjunction with FIG. 2.

The virtual TSN node/wireless communication network 80 comprises the RAN and the CN. The RAN comprises the network node 40a. The CN comprises network functions such as, the AMF 42, the SM F 44, the PCF 48, the NEF 54, the UDM 52, the UPF 46, or the like. All these network functions of the CN are described in detail in conjunction with FIG. 3.

In some examples, the virtual TSN node/wireless communication network 80 may define several gateways, which enable the virtual TSN node 80 to communicate with the TSN system 100 and the CNC 90. The gateways may include the TSN AF 85, a device side TSN translator, DS-TT, 20, on the UE 30, and a network side TSN translator, NW-TT, 75 on the UPF 46 of the CN. TSN ingress ports and egress ports may be provided via the DS-TT 20 on the UE 30 and via the NW-TT 75 on the CN.

The TSN AF 85 may be configured to connect the CNC 90, the CUC 95 entities and a control plane, C-plane. In some examples, the TSN AF may be associated with the CN. In some examples, the TSN AF may be a third party entity outside an operator network or an entity inside the operator network. For example, the TSN AF 85 may be an entity within the CN, which is inside the operator network, since the CN corresponds to an essential function for supporting TSN. The TSN AF 85 may derive information about a TSN stream from information provided by the CNC 90 in the form of bridge management information, and possibly using other configuration data. The TSN AF 85 may determine QoS parameters including: a priority, a Maximum Burst Size, a delay and a Maximum Bitrate, and may provide these parameters to the PCF 48.

In some examples, the DS-TT 20 and the NW-TT 75 may support hold and forward functionality of purpose of de-jittering, and per-stream filtering and policing as defined in clause 8.6.5.1 of IEEE std 802.1Q. The DS-TT 20 may optionally support link layer connectivity discovery and reporting as defined in IEEE std 802.1AN for discovery of the end stations attached to the DS-TT 20. The NW-TT 75 may support link layer connectivity discover and reporting as defined in IEEE std 802.1AB for discovery of the end stations attached to the NW-TT 75. If the DS-TT 20 does not support the link layer connectivity discovery and reporting, the NW-TT 75 may perform the link layer connectivity discovery and reporting as defined in IEEE std 802.1AB for discovery of the end stations attached to the DS-TT 20 on behalf of the DS-TT 20.

Further, as depicted in FIG. 4B, the CNC 90 may be configured to configure and operate the TSN nodes 70a and 70b of the TSN system 100 and the virtual TSN node 80. Configuring, by the CNC, the TSN nodes 70a and 70b of the TSN system 100 and the virtual TSN node 80 are described in detail in FIG. 2.

The CNC 90 operates the virtual TSN node 80 by considering the virtual TSN node as the TSN node. However, there are some substantial difference between the virtual TSN node 80 and the TSN node 70a/70b. As these differences are hidden from the CNC 90, it may result in suboptimal behaviour with respect to leveraging capabilities of the wireless communication network 80. In addition, at least one event (for example, a mobility/handover of the UE 30 to other network node 40a, a change of carrier frequency of the UE 30, connection or disconnection of the UE 30 from the UPF 46, a change in an operation mode of the network node 40a), and so on, vary radio link characteristics of the UE 30. In such a scenario, the CNC 90 has to reconfigure the TSN system 100. However, the varied radio link characteristics of the UE 30 are not reported to the CNC 90 (i.e., hidden from the CNC 90). Thus, the TSN system 100 may not be reconfigured, which affects performance/latency of the TSN streams related to the UE 30 flowing between the DS-TT 20 and the NW-TT 75 or performance between the DS-TT 20 and the NW-TT 75.

Therefore, according to some embodiments of the present disclosure, the network node 40a in the wireless communication network/virtual TSN bridge 80, implements a method for transmission of Radio Access Network, RAN, assistance information for time sensitive communication in the TSN system 100.

The network node 40a detects an occurrence of an event causing variation of radio link characteristics of the UE(s) 30 connected to the network node 40a. In some examples, the event may comprise one or more of: a handover of the UE 30 to another network node, a change of a carrier frequency of the UE, connection and/or disconnection of the UE 30 from the UPF 46, a change in performance of at least one TSN stream (related to the UE 30) flowing between the DS-TT 20 and the NW-TT 75, a change in a mapping between the DS-TT 20 and the NW-TT 75, a change in an operation mode of the network node 40a, and a change in latency characteristics of the operation mode of the network node 40a.

Upon detecting the occurrence of the event, the network node 40a transmits the RAN assistance information comprising information indicating variation of the one or more metrics of the UE 30 intended to the CNC 90, causing the CNC 90 to enable reconfiguration of the TSN system 100. In some examples, the RAN assistance information may comprise one or more of: information about latency measured in the network node 40a, information about latency distribution in the TSN system 100, and information about downlink and uplink latency related to the at least one TSN stream of the UE 30.

Thus, the RAN assistance information may be dynamically reported to the CNC 90 for reconfiguration of the TSN system 100.

According to some embodiments of the present disclosure, the CNC 90 connected to the wireless communication network/virtual TSN bridge 80 implements a method for reception of the RAN assistance information for time sensitive communication in the TSN system 100.

The CNC 90 receives, from the network node 40a through the CN, the RAN assistance information comprising information indicating varied radio link characteristics of the UE(s) 30 connected to the network node 40a. In accordance with the RAN assistance information, the CNC 90 performs reconfiguration of the TSN system 100. In some examples, performing reconfiguration of the TSN system 100 may comprise updating port configurations for the DS-TT 20 associated with the UE 30, and updating latency characteristics of the DS-TT 20 associated with the UE 30.

Thus, reconfiguring the TSN system 100 based on the RA N assistance information may not affect performance/latency of at least one TSN stream related to the UE 30 flowing between the DS-TT 20 and the NW-TT 75.

Various examples for transmission and reception of the RAN assistance information for time sensitive communication in the TSN system are explained in conjunction with figures in the later parts of the description

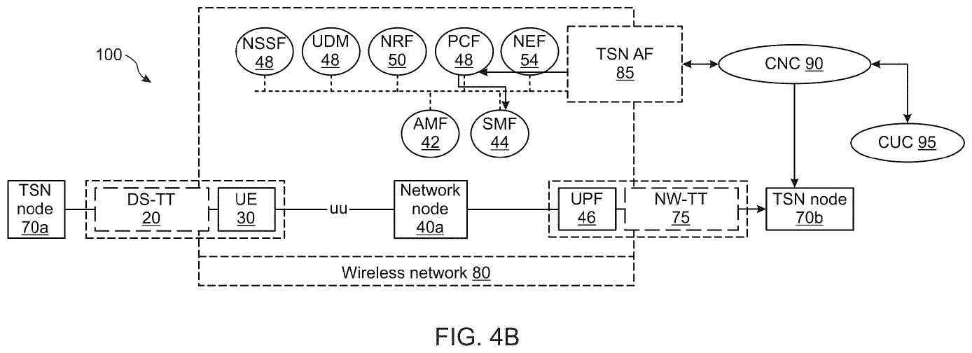

FIG. 5 is a flowchart illustrating example method steps of a method 500 performed by the network node in the wireless communication network for transmission of the RAN assistance information for time sensitive communication in the TSN system. The TSN system is integrated to the wireless communication network operating as the virtual TSN node, wherein the virtual TSN node being connected to the plurality of TSN nodes.

At step 502, the method 500 comprises detecting an occurrence of an event causing variation of radio link characteristics of one or more U Es connected to the network node. In some examples, the radio characteristics may include latency characteristics due to change in carrier frequency of the UE or due to handover of the U Es connected to the network node.

In some embodiments, the step 502 of detecting the occurrence of the event comprises obtaining information identifying at least one of one or more metrics related to the radio link characteristics for monitoring and at least one of the one or more User Equipments, UEs. The information identifying the one or more UEs and the associated one or more metrics may be received by the network node from the TSN AF through one or more network functions of the CN connected to the network node. For example, once a configuration of the TSN stream is performed, the TSN AF may indicate the PCF about the information indicating the one or more UEs and the associated one or more metrics to be monitored. The PCF may forward the received information from the TSN AF to the SMF and the SMF may further forward the received information from the PCF to the network node.

Upon obtaining the information, the method comprises monitoring the identified one or more metrics for the identified one or more UEs for detecting the occurrence of the event. In some examples, the network node in conjunction with the SMF may monitor the indicated one or more UEs and the associated one or more metrics. When it has been determined that the one or more metrics are varied, the method comprises detecting the occurrence of the event causing variation of the radio link characteristics of the one or more UEs.

In some examples, the one or more metrics related to the radio link characteristics of the UE may comprise one or more of: the DS-TTs being utilized for one or more TSN streams associated with the one or more UEs, and a mapping between the DS-TTs and the NW-TTs.

In some examples, the event causing variation of the radio link characteristics of the one or more UEs may comprise one or more of: a handover of the one or more UEs to another network node, a change of a carrier frequency of the one or more UEs, connection and/or disconnection of the one or more UEs from the UPF of the CN connected to the network node, a change in performance of at least one TSN stream flowing between the DS-TTs and the NW-TTs, a change in a mapping between the DS-TTs and the NW-TTs, a change in port pair of DS-TT, a change in an operation mode of the network node, and a change in latency characteristics of the operation mode of the network node. In some examples, another network node may be a network node having different carrier frequencies or configurations compared to the network node with which the one or more U Es have been connected. In some examples, the operation mode/operation point of the network node may correspond to operation of the network node in different RAN configurations (for example, different carriers, stationary/mobile, or the like).

Upon detecting the occurrence of the event, at step 504, the method 500 comprises transmitting the RAN assistance information comprising the information indicating the variation of the radio link characteristics of the one or more UEs, intended to the CNC, causing the CNC to enable reconfiguration of the TSN system.

In some examples, the RAN assistance information may comprise one or more of: information about latency measured in the network node, information about latency distribution in the TSN system, and information about downlink and uplink latency related to the at least one TSN stream.

In some embodiments, the step 504 of transmitting the RAN assistance information may comprise measuring the varied radio link characteristics of the one or more UEs. In some examples, the varied radio link characteristics may be measured in accordance with 3GPP TS 38.314. In accordance with the measurement, the method may comprise generating the RAN assistance information for indicating variation of the radio link characteristics of the one or more UEs. The method may comprise transmitting the RAN assistance information intended to the CNC. In some examples, if the radio link characteristics of the one or more UEs are varied due to the event such as the change in the operation mode, then the network node may transmit the RAN assistance information intended to the CNC proactively. Transmitting the RAN assistance information intended to the CNC proactively or in a proactive manner may involve transmitting the RAN assistance information intended to the CNC, when the UE moves from a midband to millimeter Wave, mmWave. Transmission of the RAN assistance information to the CNC in proactive manner may enable the CNC to pre-plan the configuration of the TSN system for the different operation modes of the network node proactively.

In some embodiments, the step of transmitting the RAN assistance information may comprise transmitting the RAN assistance information intended to the CNC through the TSN AF. In some examples, the RAN assistance information is transmitted from the network node to the TSN AF through the SMF of the CN. In some embodiments, transmission of the RAN assistance information to the TSN AF through the SM F may comprise deriving, at the SMF, from the RAN assistance information, latency parameters for each TSN stream associated with the one or more UEs, and forwarding the derived latency parameters from the SMF to the TSN AF.

In some examples, the latency parameters may comprise one or more of: updated minimum/maximum latency between the DS-TTs associated with the one or more UEs and maximum latency monitored during the occurrence of the event for each TSN stream. In some examples, an L2 measurement may be performed by the network to derive the minimum/maximum latency between the DS-TTs associated with the one or more UEs.

Thus, dynamic reporting of the RAN assistance information to the CNC reflects the CNC about the varied radio link characteristics due to the event like the handover/mobility of the UE, the change in the network node towards the DS-TT, the NW-TT and the DS-TT, the change in the DS-TT pair, the change in the operation mode of the network node, the change in the latency characteristics of the operation mode, and so on.

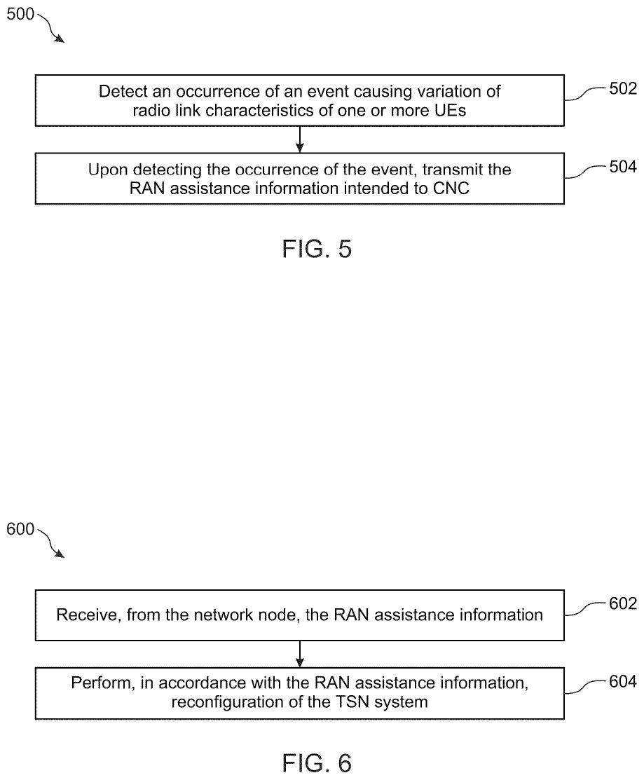

FIG. 6 is a flowchart illustrating example method steps of a method 600 performed by the CNC connected to the wireless communication network for reception of RAN assistance information for time sensitive communication in the TSN system. The TSN system is integrated to the wireless communication network operating as the virtual TSN node, wherein the virtual TSN node being connected to the plurality of TSN nodes.

At step 602, the method 600 comprises receiving, from the network node, the RAN assistance information comprising information indicating variation of radio link characteristics of the one or more UEs connected to the network node. In some examples, the RAN assistance information may comprise one or more of: information about latency measured in the network node, information about latency distribution in the TSN system, and information about downlink and uplink latency related to the at least one TSN stream.

At step 604, the method 600 comprises performing, in accordance with the RAN assistance information, reconfiguration of the TSN system. In some examples, the TSN AF in conjunction with the CNC may perform the reconfiguration of the TSN system in accordance with the RAN assistance information. Performing reconfiguring of the TSN system may include reconfiguring the TSN nodes of the TSN system and the wireless communication network operating as the virtual TSN node. In some embodiments, the step of performing the reconfiguration of the TSN system may comprise one or more of: updating port configurations for the DS-TTs associated with the one or more UEs, and updating latency characteristics of the DS-TT associated with the one or more UEs.

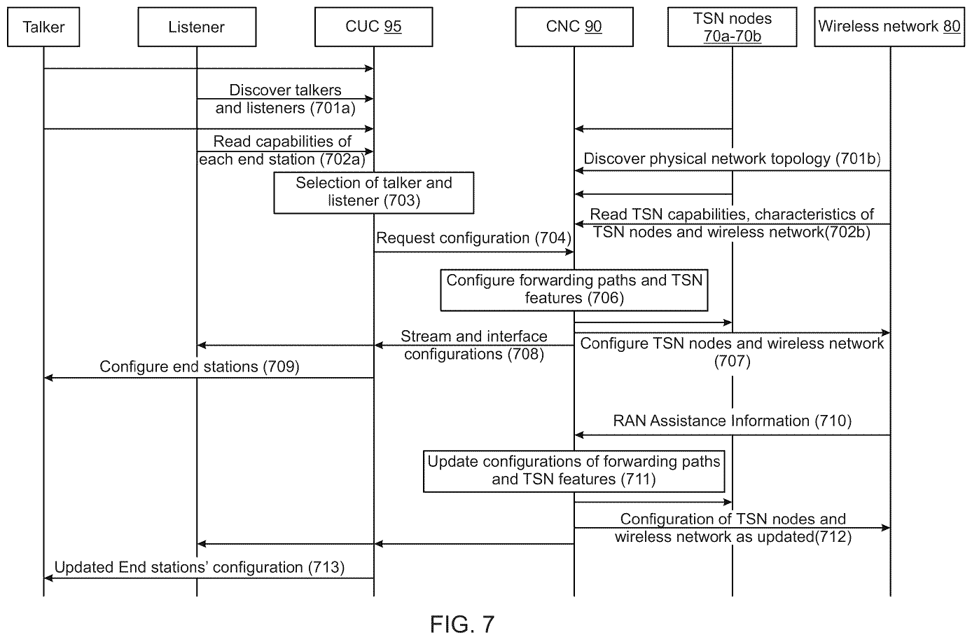

FIG. 7 is a signaling diagram illustrating example signaling for configuring and reconfiguring the TSN system. As depicted in FIG. 7, the TSN system comprising the TSN nodes 70a and 70b may be integrated to the wireless communication network 80 operating as the virtual TSN node. The CNC 90 operates the TSN nodes 70a and 70b and the wireless communication network/virtual TSN node 80.

The CUC 95 discovers (701a) a talker and a listener supposed to exchange time sensitive communication/TSN streams. In some examples, if the integration of the TSN system to the wireless communication network 80 is deployed in an automated industry, the CUC 95 receives an input from an industrial application/engineering, for example, a Programmable Logic Controller, PLC, which indicates the talkers and listeners supposed to exchange the time sensitive communication. Herein, the talker may be a sender or source end station and the listener may be a receiver or destination end station.

Upon discovering the talker and the listener, the CUC 95 reads (702a) capabilities of the talker and listener (the end stations) in the TSN system that includes information about period/interval of user traffic and payload sizes.

Based on the capabilities of the talker and the listener, the CUC 95 selects (703) the talker and listener for each TSN steam and creates other stream related information such as, but are not limited to, a stampID as an identifier for each TSN stream, a stream rank, and user to network requirements.

Meanwhile, the CNC 90 discovers (701b) a physical network topology using, for example, a Link Layer Discovery Protocol, LLDP, and any network management protocol, such as, a Remote Management Protocol, RM P. The CNC 90 reads (702b) TSN capabilities of the TSN nodes, for example, TSN nodes 70a and 70b, (for example, IEEE 802.1Q, 802.1AS, 802.1CB) in the TSN system by means of the network management protocol.

Upon selecting the talker and listener for each TSN stream (at step 703), the CUC 95 initiates (704) join requests to configure the TSN stream in order to configure network resources at the TSN nodes 70a and 70b for the TSN stream from the talker to the listener. Also, the CUC 95 may create talker and listener groups (a group of elements specifying the TSN stream) as specified in IEEE 802.1Q.

Based on the initiated join request, the CNC 90 configures (706) forwarding paths for the TSN streams and TSN features (for example, IEEE 802.1AS time synchronization). Based on the configured forwarding paths and the TSN features, the CNC 90 configures (707) the TSN nodes 70a and 70b and the wireless communication network 80. The CNC 90 transmits (708) stream and interface configurations to the CUC 95. The CNC 90 configures (709) the end stations/talker and listener.

On configuring the TSN nodes 70a and 70b, the wireless communication network 80, and the end stations, the wireless communication network 80 transmits (710) RAN assistance information intended to the CNC 90. The wireless communication network 80 transmits the RAN assistance information to the CNC 90, upon detection of the event causing variation of the radio link characteristics of the one or more UEs connected to the network node in the wireless communication network. In some examples, the event may include, but are not limited to, a handover of the one or more UEs to another network node, a change of carrier frequency of the one or more UEs, connection and/or disconnection of the one or more U Es from the U PF of the CN connected to the network node, a change in performance of at least one TSN stream flowing between the DS-TTs associated with the one or more UEs and the NW-TTs associated with the UPF, a change in a mapping between the DS-TT and the NW-TT, a change in an operation mode of the network node, or any other event causing the variation of the radio link characteristics of the one or more UEs.

In some examples, the RAN assistance information may comprise one or more of: information about latency measured in the network node, information about latency distribution in the TSN system, and information about downlink and uplink latency related to the at least one TSN stream.

Upon receiving the RAN assistance information, the CNC 90 updates/reconfigures (711) the forwarding paths and the TSN features in accordance with the received RAN assistance information. Based on the reconfigured forwarding paths and the TSN features, the CNC 90 reconfigures (712) the TSN nodes 70a and 70b and the wireless communication network 80. The CNC 90 also reconfigures (713) the end stations/talkers and listeners. Thereby, reconfiguring the TSN system on detecting the event causing variation of the radio link characteristics of the one or more UEs.

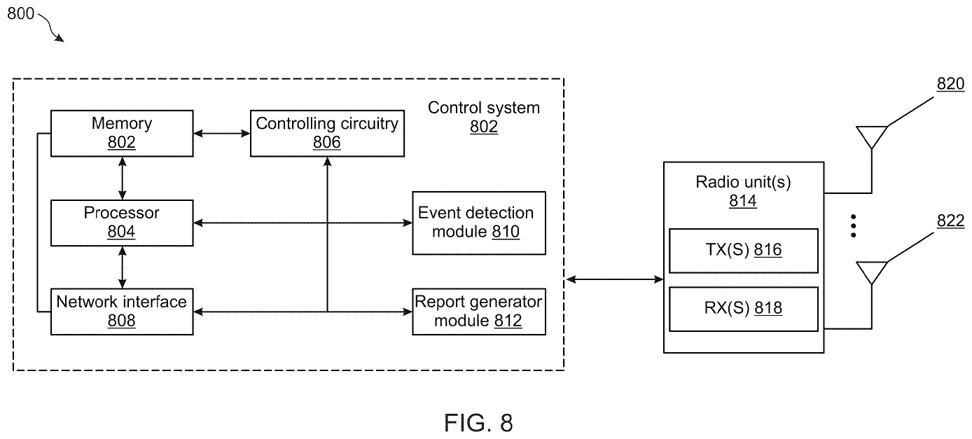

FIG. 8 is a schematic block diagram illustrating an example apparatus 800 in the network node of the wireless communication network. The apparatus 800 may e.g. be comprised in the network node. The apparatus 800 is capable of performing transmission of RAN assistance information for time sensitive communication in the TSN system and may be configured to cause performance of the method 500 for transmission of the RAN assistance information for time sensitive communication in the TSN system.

As depicted in FIG. 8, the apparatus 800 comprises a control system 802 that includes a memory 802a, one or more processors 804, a controlling circuitry 806, a network interface 808, an event detection module 810, and a report generator module 812. The memory 802a, the one or more processors 804, the controlling circuitry 806, the network interface 808, an event detection module 810, and the report generator module 812 may be operatively connected to each other. Examples of the one or more processors 804 (also referred to as processing circuitry) may include, Central Processing Units, CPUs, Application Specific Integrated Circuits, ASICs, Field Programmable Gate Arrays, FPGA s, and so on.

In addition, the apparatus 800 comprises radio units 814 that each includes one or more transmitters 816 and one or more receivers 818 coupled to one or more antennas 820 and 822. The radio units 814 may be referred to or be part of radio interface circuitry. In some embodiments, the radio unit(s) 814 is external to the control system 802 and connected to the control system 802 via, e.g., a wired connection (e.g., an optical cable). However, in some other embodiments, the radio unit(s) 814 and potentially the antenna(s) 820 and 822 are integrated together with the control system 802.

The controlling circuitry 806, may in some embodiments be adapted to control the above mentioned components of the apparatus 800. The controlling circuitry 806 may be adapted to control the steps as executed by the network node. For example, the controlling circuitry 806 may be adapted to perform transmission of the RAN assistance information for time sensitive communication in the TSN system (as described above in conjunction with the method 500 and FIG. 5).

The event detection module 810 may be adapted to detect an occurrence of an event causing variation of radio link characteristics of the one or more UEs connected to the network node. In some examples, the event detection module 810 may detect the occurrence of the event by monitoring one or more metrics related to the radio link characteristics of the one or more UEs.

The report generator module 812 may be adapted to generate the RAN assistance information by measuring the radio link characteristics of the one or more UEs.

The network interface 808 may be adapted to transmit the RAN assistance information intended to the CNC.

The one or more processors 804 may be adapted to perform other radio operations of the network node.

The memory 802a may store at least one of, information indicating the one or more UEs and the associated one or more metrics to be monitored, the RAN assistance information, and so on.

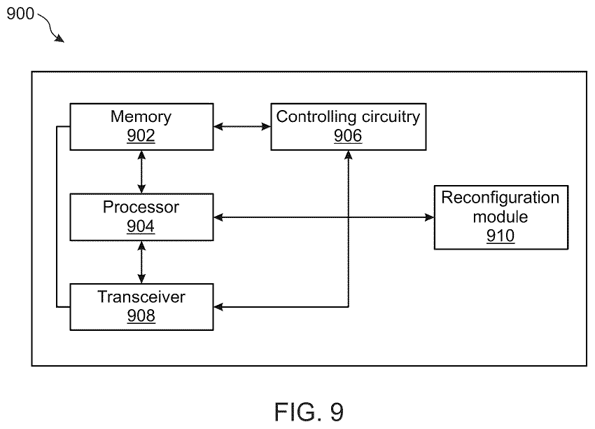

FIG. 9 is an example schematic diagram showing an apparatus 900. The apparatus 900 may e.g. be comprised in the CNC. The apparatus 900 is capable of performing reception of RAN assistance information for time sensitive communication in the TSN system and may be configured to cause performance of the method 600 for reception of RAN assistance information for time sensitive communication.

According to at least some embodiments of the present invention, the apparatus 900 in FIG. 9 comprises one or more modules. These modules may e.g. be a memory 902, a processor 904, a controlling circuitry 906, a transceiver 908, and a reconfiguration module 910. The controlling circuitry 906, may in some embodiments be adapted to control the above mentioned modules.

The memory 902, the processor 904, the transceiver 908, and the reconfiguration module 910 as well as the controlling circuitry 906, may be operatively connected to each other.

The controlling circuitry 906 may be adapted to control the steps as executed by the CNC. For example, the controlling circuitry 906 may be adapted to perform reception of RAN assistance information for time sensitive communication in the TSN system (as described above in conjunction with the method 600 and FIG. 6).

The transceiver 908 may be adapted to receive the RAN assistance information from the network node through the CN in the wireless communication network. The RAN assistance information comprises information indicating variation of radio link characteristics of the one or more UEs.

The reconfiguration module 910 may be adapted to reconfigure the TSN system in accordance with the received RAN assistance information.

The processor 904 may be adapted to operate the TSN system and the wireless communication network operating as the virtual TSN node.

Further, the memory 902 may store at least one of, the RAN assistance information, information about configuration and reconfiguration of the TSN system, and so on.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors, DSPs, special-purpose digital logic, and the like. The processing circuitry may be configured to execute program code stored in memory, which may include one or several types of memory such as read-only memory (ROM), random-access memory, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

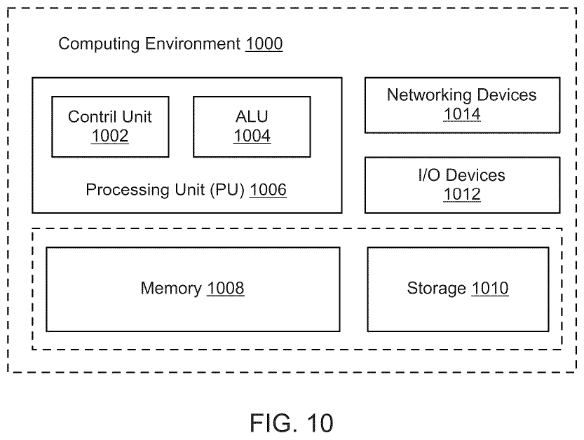

FIG. 10 illustrates an example computing environment 1000 implementing a method and the apparatus, as described in FIGS. 5 and 8, and FIGS. 6 and 9. As depicted in FIG. 10, the computing environment 1000 comprises at least one data processing module 1006 that is equipped with a control module 1002 and an Arithmetic Logic Unit (ALU) 1004, a plurality of networking devices 1014 and a plurality Input output, I/O devices 1012, a memory 1008, a storage 1010. The data processing module 1006 may be responsible for implementing the method described in FIGS. 5 and 6. For example, the data processing module 1006 may in some embodiments be equivalent to the CPU/processor of the apparatus described above in conjunction with the FIGS. 6 and 9. The data processing module 1006 is capable of executing software instructions stored in memory 1008. The data processing module 1006 receives commands from the control module 1002 in order to perform its processing. Further, any logical and arithmetic operations involved in the execution of the instructions are computed with the help of the ALU 1004.

The computer program is loadable into the data processing module 1006, which may, for example, be comprised in an electronic apparatus (such as a network node, a CNC). When loaded into the data processing module 1006, the computer program may be stored in the memory 1008 associated with or comprised in the data processing module 1006. According to some embodiments, the computer program may, when loaded into and run by the data processing module 1006, cause execution of method steps according to, for example, any of the method illustrated in FIGS. 5 and 6 or otherwise described herein.

The overall computing environment 1000 may be composed of multiple homogeneous and/or heterogeneous cores, multiple CPUs of different kinds, special media and other accelerators. Further, the plurality of data processing modules 1006 may be located on a single chip or over multiple chips.

The algorithm comprising of instructions and codes required for the implementation are stored in either the memory 1008 or the storage 1010 or both. At the time of execution, the instructions may be fetched from the corresponding memory 1008 and/or storage 1010, and executed by the data processing module 1006.

In case of any hardware implementations various networking devices 1014 or external I/O devices 1012 may be connected to the computing environment to support the implementation through the networking devices 1014 and the I/O devices 1012.

The embodiments disclosed herein can be implemented through at least one software program running on at least one hardware device and performing network management functions to control the elements. The elements shown in FIG. 10 include blocks which can be at least one of a hardware device, or a combination of hardware device and software module.

1. A method performed for transmission of Radio Access Network, RAN, assistance information for time sensitive communication in a Time-Sensitive Networking, TSN system, the method performed by a network node of a wireless communication network the wireless communication network operating as a virtual TSN, bridge of the TSN system the method comprising:
detecting an occurrence of an event causing variation of radio link characteristics of one or more User Equipments, UEs connected to the network node; and
upon detecting the occurrence of the event, transmitting the RAN assistance information, said RAN assistance information being intended for a Centralized Network Controller, CNC and comprising information indicating the variation of the radio link characteristics to enable the CNC for reconfiguration of the TSN system.

2. The method according to claim 1, wherein detecting the occurrence of the event causing variation of the radio link characteristics of the one or UEs comprising:
obtaining information identifying at least one of one or more metrics related to the radio link characteristics for monitoring and at least one of the one or more User Equipments, UEs; and
monitoring the identified one or more metrics for the identified one or more UEs for detecting the occurrence of the event.

3. The method according to claim 2, wherein the one or more metrics related to the radio link characteristics of the one or more UEs comprise more of:
the DS-TTs being utilized for one or more TSN streams associated with the one or more UEs.

4. The method according to claim 1, wherein the event comprises one or more of:
a handover of the one or more UEs to another network node;
a change of a carrier frequency of the one or more UEs;
connection or disconnection of the one or more UEs from a User Plane Function, UPF, of a core network, CN, connected to the network node;
a change in performance of at least one TSN stream flowing between device side TSN translators, DS-TTs associated with the one or more UEs and network side TSN translators, NW-TTs, associated with the UPF of the CN;
a change in a mapping between the DS-TTs and the NW-TTs;
a change in an operation mode of the network node; and
a change in latency characteristics of the operation mode of the network node.

5. The method according to claim 2 wherein transmitting the RAN assistance information intended to the CNC comprises:
measuring the one or more metrics of the one or more UEs varied due to the occurrence of the event;
generating, in accordance with the measurement, the RAN assistance information for indicating the variation of the one or more metrics of the one or more UEs; and
transmitting the RAN assistance information intended to the CNC (90).

6. The method according to claim 1 wherein transmitting the RAN assistance information comprises:
transmitting the RAN assistance information intended to the CNC through a TSN Application Function, AF.

7. The method according to claim 6, wherein the RAN assistance information is transmitted to the TSN AF through a Session Management Function, SMF of the CN.

8. The method according to claim 7, wherein transmission of the RAN assistance information to the TSN AF through the SMF comprises:
deriving, at the SMF from the RAN assistance information, one latency parameter for each TSN stream and one latency parameter for each stream for each UE; and
forwarding the derived latency parameters from the SMF to the TSN AF.

9. The method according to claim 8, wherein the latency parameters comprise of: updated minimum/maximum latency between the DS-TTs associated with the one or more UEs.

10. The method according to claim 1, the RAN assistance information comprises
information about latency measured in the network node.

11. A method performed for reception of Radio Access Network, RAN, assistance information for time sensitive communication in a Time-Sensitive Networking, TSN system, the TSN system being integrated to a wireless communication network, the wireless communication network operating as a virtual TSN bridge of the TSN system, the method being performed by a Centralized Network Controller, CNC of the TSN system, the method comprising:
receiving from a network node in the wireless communication network, the RAN assistance information comprising information indicating variation of radio link characteristics of one or more User Equipments, UEs, connected to the network node; and
performing in accordance with the RAN assistance information, reconfiguration of the TSN system.

12. The method according to claim 11, wherein performing reconfiguration of the TSN system comprises
updating port configurations for device side TSN translators, DS-TTs associated with the one or more UEs.

13. The method according to claim 11 wherein the RAN assistance information comprises
information about latency distribution in the TSN system.

14. An apparatus of a network node in a wireless communication network configured to perform transmission of Radio Access Network, RAN, assistance information for time sensitive communication in a Time-Sensitive Networking, TSN, system the wireless communication network operating as a virtual TSN bridge of the TSN system the apparatus is configured to cause:
detection of an occurrence of an event causing variation of radio link characteristics of one or more User Equipments, UEs connected to the network node; and
upon detecting the occurrence of the event, transmitting the RAN assistance information, said RAN assistance information being intended for a Centralized Network Controller, CNC, and comprising information indicating the variation of the radio link characteristics to enable the CNC for reconfiguration of the TSN system.

15-27. (canceled)

28. A non-transitory computer readable medium, having thereon a computer program comprising program instructions, wherein the computer program is loadable into a data processing unit and configured to cause execution of the method according to claim 1 when the computer program is run by the data processing unit.

29. A non-transitory computer readable medium, having thereon a computer program comprising program instructions, wherein the computer program is loadable into a data processing unit and configured to cause execution of the method according to claim 11 when the computer program is run by the data processing unit.

30. The method according to claim 2, wherein the one or more metrics related to the radio link characteristics of the one or more UEs comprise a mapping between the DS-TTs and the NW-TTs.

31. The method according to claim 8, wherein the latency parameters comprise maximum latency monitored during the occurrence of the event for each TSN stream.

32. The method according to claim 11, wherein performing reconfiguration of the TSN system comprises updating latency characteristics of the DS-TTs associated with the one or more UEs.

33. The method according to claim 11, wherein the RAN assistance information comprises information about downlink and uplink latency related to at least one TSN stream associated with the one or more UEs.
